(19) United States
(12) Patent Application Publication
(10) Pub. No.: US 2020/0041719 A1
(43) Pub. Date: Feb. 6, 2020

(54) ABLATED END FIBERS AND METHODS FOR ABLATING OPTICAL FIBERS

(71) Applicant: AFL Telecommunications LLC, Duncan, SC (US)

(72) Inventors: Wenzin Zheng, Moore, SC (US); Mohamed Amine Jebali, Duncan, SC (US); Gongwen Zhu, Woodruff, SC (US)

(21) Appl. No.: 16/518,288

(22) Filed: Jul. 22, 2019

Related U.S. Application Data
(60) Provisional application No. 62/704,049, filed on Jan. 23, 2019.
(60) Provisional application No. 62/714,306, filed on Aug. 3, 2018.

(51) Int. Cl. G02B 6/02; G02B 6/14; H01S 3/223; H01S 3/067; G02B 6/25

(52) U.S. Cl. CPC G02B 6/02066; G02B 6/14; H01S 3/094007; H01S 3/06729; G02B 6/25; H01S 3/2232

(57) ABSTRACT

A method for ablating an optical fiber includes generating a laser beam for a plurality of discrete time periods. The laser beam impacts and ablates the optical fiber during each discrete time period. Each discrete impact of the laser beam during one of the plurality of discrete time periods is at a different location on a surface of the cladding. The ablation of the optical fiber during the plurality of discrete time periods forms a plurality of discrete craters. The plurality of discrete craters are spaced apart from each other in an array which extends along a longitudinal axis of the optical fiber and about a circumference of the optical fiber. An ablated end fiber includes a core, a cladding surrounding the core, and a plurality of discrete craters defined in the ablated end fiber.

### CROSS-REFERENCE TO RELATED APPLICATIONS

The present application claims priority to U.S. Provisional Patent Application Ser. No. 62/714,306, filed Aug. 3, 2018, and to U.S. Provisional Patent Application Ser. No. 62/704,049, filed Jan. 23, 2019, both of which are incorporated by reference herein in their entireties.

### FIELD

The present disclosure relates generally to ablated optical fibers, which may for example be utilized as cladding mode strippers or diffusers, as well as to methods for ablating optical fibers, such as to form ablated end fibers.

### BACKGROUND

Cladding mode strippers are fiber optic components used to strip out unabsorbed cladding light in order to obtain a cleaner output signal. Conventional methods for forming such cladding mode strippers utilize acid etching, sand blasting or CO₂ laser ablation. When conventional CO₂laser ablation methods are used, transversal notches, rings, or spirals are generated by the CO₂ laser to strip out the cladding power.

For example, FIG. 1 illustrates a known ablated end fiber utilized as a cladding mode stripper. The end fiber includes transverse grooves or notches formed by a CO₂ laser beam. The grooves/notches have uniform pitch and uniform penetration into the optical fiber. The transverse grooves/notches made by the CO₂ laser beam can break the transmission of the cladding mode(s) in the optical fiber. The light power of the cladding modes are then leak to the surrounding space of the fiber.

However, there are two major issues with known cladding mode stripper structures such as those discussed above. First, the fiber tensile strength is very much weakened due to the transversal groove/notch design. Glass mini-fractures or cracks may be induced by the grooves/notches, and may then propagate in a transversal direction along the grooves/notches, eventually causing the fiber to break during application. Second, to keep the necessary tensile strength, the grooves/notches have to be ablated relatively shallow. Accordingly, the cladding power stripping efficiency (dB/mm) is low. Therefore, to strip enough cladding power, the stripper length has to be relatively long. For example, in some cases, to reach 25 dB power loss while keeping a reasonable strength, the stripper has to be 40 mm to 80 mm long.

Accordingly, improved methods for ablating optical fibers, and improved ablated end fibers, are desired. In particular, methods and ablated end fibers which address one or more of the above-discussed concerns would be advantageous.

### BRIEF DESCRIPTION

Aspects and advantages of the invention will be set forth in part in the following description, or may be obvious from the description, or may be learned through practice of the invention.

In accordance with one embodiment, a method for ablating an optical fiber is provided. The optical fiber includes a core and a cladding. The method includes generating a laser beam for a plurality of discrete time periods. The laser beam impacts and ablates the optical fiber during each discrete time period. Each discrete impact of the laser beam during one of the plurality of discrete time periods is at a different location on a surface of the cladding. The ablation of the optical fiber during the plurality of discrete time periods forms a plurality of discrete craters. The plurality of discrete craters are spaced apart from each other in an array which extends along a longitudinal axis of the optical fiber and about a circumference of the optical fiber.

In accordance with another embodiment, an ablated end fiber is provided. The ablated end fiber includes a core, a cladding surrounding the core, and a plurality of discrete craters defined in the ablated end fiber. The plurality of discrete craters are spaced apart from each other in an array which extends along a longitudinal axis of the optical fiber and about a circumference of the optical fiber.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE FIGURES

A full and enabling disclosure of the present invention, including the best mode thereof, directed to one of ordinary skill in the art, is set forth in the specification, which makes reference to the appended figures, in which:

FIG. 1 is a perspective view of prior art ablated optical fiber;

FIG. 2 is a perspective view of an ablated optical fiber in accordance with embodiments of the present disclosure;

FIG. 3 is a side cross-sectional view illustrating a portion of an ablated optical fiber in accordance with embodiments of the present disclosure; and

FIG. 4 is an end cross-sectional view illustrating a portion of an ablated optical fiber in accordance with embodiments of the present disclosure;

FIG. 5 is a perspective view illustrating an optical fiber being ablated by a laser beam to form a discrete crater;

FIG. 6 is a perspective view illustrating an optical fiber being ablated by a laser beam to form a subsequent discrete crater;

FIG. 7 is a sample ablated optical fiber produced in accordance with embodiments of the present disclosure;

FIG. 8 is a cross-sectional view of a sample ablated optical fiber produced in accordance with embodiments of the present disclosure;

FIG. 9 is a schematic ablated optical fiber experimental characterization setup in accordance with embodiments of the present disclosure;

FIG. 10 is a chart illustrating temperature measurement at different power levels for an ablated optical fiber in accordance with embodiments of the present disclosure;

FIG. 11 is a high resolution image converter picture of an ablated optical fiber of variable depth at 120 W in accordance with embodiments of the present disclosure;

FIG. 12 is a thermal image of the ablated optical fiber of FIG. 11; and

FIG. 13 is a machine utilized to manufacture ablated optical fibers in accordance with embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

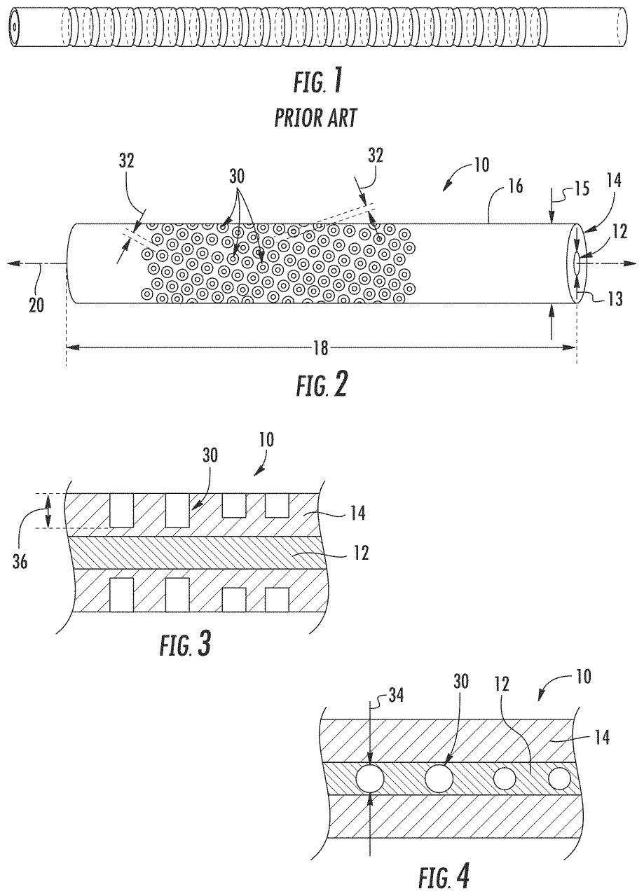

Referring now to FIGS. 2 through 4, embodiments of ablated end fibers 10 in accordance with the present disclosure are illustrated. Such end fibers 10 can be utilized as cladding mode (also known as cladding light) strippers or diffusers, or may alternatively be utilized in various other applications. Ablated end fibers 10 in accordance with the present disclosure provide numerous advantages. For example, the use of a matrix of holes or discrete craters as discussed herein advantageously reduces the risk of linear stress concentrations as compared to known cladding mode strippers and ablated end fibers. Such matrix of discrete craters is further less likely to result in mini-fractures or cracks propagating along a transverse direction to the fiber axis. Further, various parameters of the discrete craters, such as location, maximum diameter, maximum depth, angle, spacing, pattern, etc., can be varied and customized per application, such as in some embodiments to increase cladding light absorption. One or more of the parameters may thus be the same for all discrete craters defined in the optical fiber, or that parameter(s) may be the same within a subset of craters but different from others within separate subsets of craters, or that parameter(s) may vary throughout the plurality of craters.

For example, in some embodiments, some of the individual craters can be made much deeper to increase the power stripping efficiency without a strong impact on the tensile strength of the fiber. In some embodiments, for example, the laser ablation penetration (and thus the crater depth) is increased in the direction of propagation of light in order to increase the cladding light absorption of the components. This increase in penetration can be linear or non-linear depending of the desired heat distribution profile. In some embodiments, by varying the location and the number of holes along a longitudinal axis and/or annularly about the optical fiber, a desired radiation pattern can be generated for a side-fire optical fiber device used in medical treatment, such as Calcified Plaque Removal in coronary arteries. Such optical fibers can also be used in transmitted light filtering, such as long period fiber gratings.

In exemplary embodiments, ablated end fibers 10 in accordance with the present disclosure are multi-mode optical fibers or large mode area (“LMA”) optical fibers. Alternatively, however, other suitable optical fibers may be utilized.

An ablated end fiber 10 in accordance with the present disclosure may include a core 12 and a cladding 14 which surrounds the core 12, as is generally understood. A maximum outer diameter 13 may be defined for the core 12, and a maximum outer diameter 15 may be defined for the cladding 14.

Maximum outer diameter 13 may, for example, be 50 microns (plus or minus 3 microns) or 62.5 microns (plus or minus 3 microns). Alternatively, maximum outer diameter 13 may have another suitable size. Maximum outer diameter 16 may, for example, be 125 microns (plus or minus 3 microns) or between 150 microns and 800 microns (plus or minus 3 microns), or between 400 microns and 600 microns (plus or minus 3 microns). Alternatively, maximum outer diameter 13 may have another suitable size. In some embodiments, the end fiber is a 20/400/440 LMA fiber.

An outer surface 16 of the cladding 14 may be defined for the ablated end fiber 10. Additionally, a maximum length 18 along a longitudinal axis 20 may be defined for the ablated end fiber 10. The maximum length 18 may, in exemplary embodiments, be less than 40 millimeters, such as less than 35 millimeters, such as less than 30 millimeters.

As discussed, a plurality of discrete craters 30 may be defined in the ablated end fiber 10. Each crater 30 may be spaced apart from other craters 30 in the plurality of craters 30. For example, a distance 32 may be defined between a crater 30 and a neighboring crater 30. The plurality of discrete craters 30 may be spaced apart from each other in an array which extends along the longitudinal axis 20 of the optical fiber and about a circumference of the ablated end fiber 10, as shown.

Each discrete crater 30 may extend into the cladding 14 through the outer surface 16 thereof. In exemplary embodiments, each discrete crater 30 extends only into the cladding 14, and does not extend into the core 12. Accordingly, the core 12 may be free from craters 30.

Each discrete crater 30 may have a maximum diameter 34 and a maximum depth 36. The maximum diameter 34 of each discrete crater 30 may, for example, be greater than 20 microns, such as greater than 30 microns, such as between 20 microns and 100 microns, such as between 30 microns and 90 microns, such as between 40 microns and 80 microns. The maximum depth 36 of each discrete crater 30 may, for example, be between 10 microns and 300 microns, such as between 20 microns and 250 microns, such as between 30 microns and 200 microns, such as between 40 microns and 150 microns, such as between 50 microns and 100 microns. In some exemplary embodiments, the maximum depth 35 is between 20 microns and 50 microns, such as between 25 microns and 45 microns, such as between 30 microns and 40 microns, such as between 33 and 37 microns, such as approximately 35 microns.

In some embodiments, the maximum depths 36 of discrete crater(s) 30 in a first subset of the plurality of discrete crater 30 (which itself may include one or more discrete craters 30) may be greater than the maximum depths 36 of discrete crater(s) 30 in a second subset of the plurality of discrete crater 30 (which itself may include one or more discrete craters 30). Additionally or alternatively, the maximum depths 36 of the craters 30 may vary along the longitudinal axis 20. For example, the maximum depths 36 may increase along the longitudinal axis 20. Additionally or alternatively, the maximum depths 36 of the craters 30 may increase along a direction of light propagation through the ablated end fiber 10. Such direction may be a direction along which light may propagate during use of the fiber 10.

In some embodiments, one or more of the craters 30 may extend along a direction perpendicular to the longitudinal axis 20, such as in a radial direction. Alternatively, one or more craters 30 may extend at an angle to such direction(s).

In some embodiments, the craters 30 may be provided in a pattern. For example, in a first subset of craters 30, each crater may be rotationally and translationally offset from others of the subset, with the rotational and translational offset being generally consistent between the craters 30 in the first subset. The first subset may then be repeated, such as between 2 and 100 times, such as between 10 and 90 times, such as between 30 and 80 times, such as between 50 and 80 times, such as between 60 and 80 times. The result may, for example, be a uniform distribution of craters 30 along and about the longitudinal axis 20.

Referring now to FIGS. 5 and 6, the present disclosure is further directed to methods for ablating optical fibers 10. The resulting optical fiber 10 may be an ablated end fiber 10 as discussed herein. A method may include, for example, the step of generating a laser beam 100 for a plurality of discrete time periods. During each discrete time period, the laser beam 100 may impact and ablate the optical fiber 10. Further, each discrete impact of the laser beam 100 during a discrete time period may occur at a different location (from all other discrete impacts) on a surface 16 of a cladding 14 of the optical fiber 10. Ablation of the optical fiber 10 during the plurality of discrete time periods forms a plurality of discrete craters 30, the plurality of discrete craters 30 spaced apart from each other in an array which extends along a longitudinal axis 20 of the optical fiber 10 and about a circumference of the optical fiber 10.

As shown, a laser 102 may generate the laser beam 100. The laser 102 in exemplary embodiments is a CO₂ laser, and the laser beam 14 is thus in exemplary embodiments a CO₂ laser beam. One example of a suitable laser 102 is the laser component of an AFL Telecommunications LZM-120A+ machine. An exemplary such machine is shown in FIG. 13. In exemplary embodiments, the laser 102 may be set to operate at a frequency in a range between 1 and 10 k Hertz, although alternatively other suitable frequencies may be utilized. The laser beam 100 generated by the laser 102 may impact the optical fiber 10. In some embodiments, mirrors, lens, and other suitable apparatus may be utilized to direct, amplify, and otherwise modify the laser beam 100 prior to it impacting the optical fiber 10.

The laser beam 100 may be generated, such as by the laser 102, for a plurality of discrete time periods. Each such time period may, for example, be predetermined and, for example, programmed into a controller of the apparatus being utilized to perform such method, which may for example include the laser 102. The discrete laser beam 100 may impact the outer surface 16 of the cladding 14 at a discrete location, forming a discrete crater 30 in the optical fiber 10. The discrete time period may, for example, be between 30 microseconds and 500 milliseconds, such as between 100 microseconds and 400 milliseconds, such as between 5 milliseconds and 200 milliseconds, such as between 10 milliseconds and 100 milliseconds.

As each time period is discrete, there may be a pause in the generation of the laser beam 100 between each time period of generation. Such time period of pause may, for example, be predetermined and, for example, programmed into a controller of the apparatus being utilized to perform such method, which may for example include the laser 102. Such discrete time period may, for example, be between 1 microsecond and 10 milliseconds, such as between 10 microseconds and 5 milliseconds, such as between 15 microseconds and 1 millisecond, such as between 20 microseconds and 200 microseconds. Further, during such pause and thus between the discrete time periods of laser beam 100 generation, the optical fiber 30 and/or the focal location for the laser beam 100 on the optical fiber 30 may be moved. In some embodiments, the focal point 100 may be repositioned. Additionally or alternatively, the optical fiber 30 may be moved, such as rotated about the longitudinal axis 20, translated along the longitudinal axis 20, or otherwise. Accordingly, each discrete crater 30 is formed in a location that is different from the others in the plurality of discrete craters 30. FIG. 5 illustrates a discrete crater 30 being formed via ablation by a laser beam 100 at a first location, and FIG. 6 illustrates a subsequent crater 30 being formed via ablation by a laser beam 100 at a second, distinct and different location.

### EXAMPLE

The sample featured in FIGS. 7 and 8 is a cladding light stripper (CLS) manufactured using the ablation beam path of the LZM-120A+ by drilling holes into the cladding of a 20/400/440 LMA fiber. The depths of these holes are determined by the focus position of the CO2 laser beam, and can be calibrated by drilling a series of holes on a test fiber. The series begins at the calibrated “edge” position, then translates the fiber and moves the beam focuser forward by a predetermined amount. After drilling, the fiber is defocused until the holes are visible and the appropriate depth is selected using image processing tuned to maximize cladding light extraction without affecting the signal in the core.

A series of 5 holes were drilled using incremental 120° rotations, followed by a −50° rotational offset and a 300 μm Z translation. This process was repeated 70 times along the fiber, resulting in a 21 mm long fiber with uniformly distributed ˜35 μm deep holes.

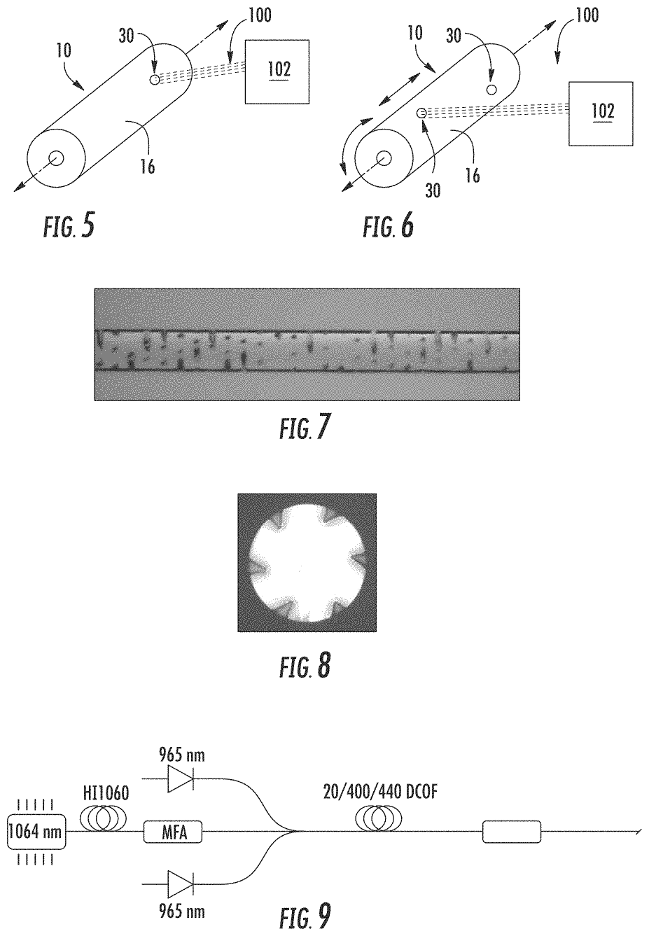

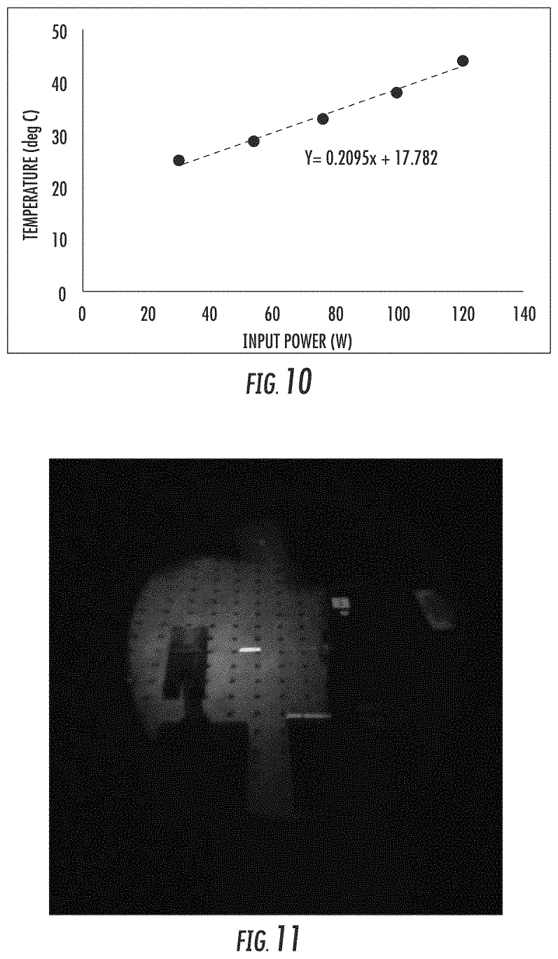

FIG. 9 depicts the CLS experimental characterization setup, where a fiber laser pump configuration is constructed. A set of 965 nm multimode pump diodes are combined using a 6+1−>1 tapered fused bundle (TFB) combiner. The output fiber of the pump diode is a 105/125 multimode fiber with a numerical aperture of 0.22. The signal fiber of the TFB is a 20/400/440 double clad optical fiber DCOF with a core NA of 0.08 and cladding NA of 0.45. The signal branch of the combiner is connected to a single mode source operating at 1064 nm and a fiber coupled into a standard 6/125 single clad fiber with a NA of 0.1. Because of the large core and NA mismatch of the two fibers, a mode field adapter (MFA) is used to properly couple light from the single mode 6 μm core into the fundamental mode of the 20 μm core of the large mode area fiber. The characterization experiment consists of a cut-back measurement of the insertion loss of the CMS for both the signal and pump light.

The CMS used for this experiment was a 21 mm long fiber with uniformly drilled 35 μm deep holes. The first step in the characterization process is to gradually increase the pump power and record the device temperature. A maximum pump power of 120 W is injected into the sample. The second step is to turn off the pump diodes and turn on the signal laser to reference the output power using an integrating sphere. The device is then removed to measure its insertion loss. The CLS cladding losses were measured to be −19.3 dB for a 21 mm long component; the highest measured temperature was 44° C. at 120 W input power.

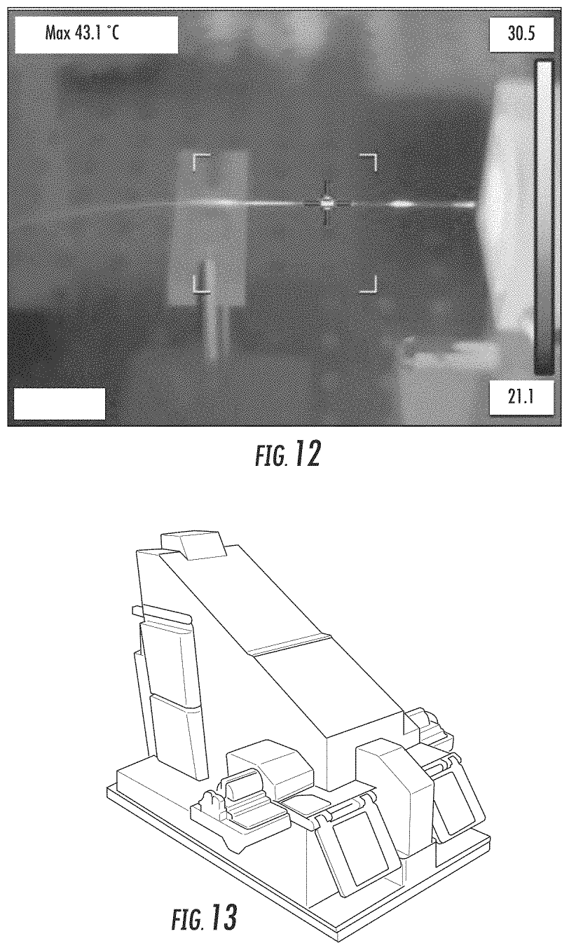

FIG. 10 shows the temperature measurement of the CLS at different power levels. The temperature of the CLS is increasing at a rate of 0.21° C. per watt of input power.

FIG. 11 shows a picture of the measurement setup for the CLS at full pump power taken with a camera equipped with a high resolution image converter that converts near infrared radiation to a bright green light. The bright spot in this picture corresponds to the gradually extracted pump power. FIG. 12 shows a thermal image of the same setup. The CLS operated at room temperature when driven at 120 W pump power. A slight increase of temperature (−30° C.) was recorded at the stripping point of the double cladding fiber.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for ablating an optical fiber, the optical fiber comprising a core and a cladding, the method comprising:
generating a laser beam for a plurality of discrete time periods, wherein the laser beam impacts and ablates the optical fiber during each discrete time period and wherein each discrete impact of the laser beam during one of the plurality of discrete time periods is at a different location on a surface of the cladding;
wherein the ablation of the optical fiber during the plurality of discrete time periods forms a plurality of discrete craters, the plurality of discrete craters spaced apart from each other in an array which extends along a longitudinal axis of the optical fiber and about a circumference of the optical fiber.

2. The method of claim 1, wherein each of the plurality of discrete craters extends only into the cladding and does not extend into the core.

3. The method of claim 1, wherein each of the plurality of discrete craters has a maximum diameter of greater than 20 microns.

4. The method of claim 1, wherein each of the plurality of discrete craters has a maximum depth of between 10 and 300 microns.

5. The method of claim 1, wherein the optical fiber is a multi-mode optical fiber.

6. The method of claim 1, wherein the optical fiber is a large mode area optical fiber.

7. The method of claim 1, wherein the optical fiber has a maximum length of less than 40 millimeters.

8. The method of claim 1, wherein the laser beam is a CO₂ laser beam.

9. The method of claim 1, wherein a first subset of the plurality of discrete craters have maximum depths that are greater than maximum depths of a second subset of the plurality of discrete craters.

10. The method of claim 1, wherein the maximum depths of the plurality of discrete craters increase along a direction of light propagation through the optical fiber.

11. An ablated end fiber, the ablated end fiber comprising:
a core;
a cladding surrounding the core; and
a plurality of discrete craters defined in the ablated end fiber, the plurality of discrete craters spaced apart from each other in an array which extends along a longitudinal axis of the ablated end fiber and about a circumference of the optical fiber.

12. The ablated end fiber of claim 11, wherein each of the plurality of discrete craters extends only into the cladding and does not extend into the core.

13. The ablated end fiber of claim 11, wherein each of the plurality of discrete craters has a maximum diameter of greater than 20 microns.

14. The ablated end fiber of claim 11, wherein each of the plurality of discrete craters has a maximum depth of between 10 and 300 microns.

15. The ablated end fiber of claim 11, wherein the optical fiber is a multi-mode optical fiber.

16. The ablated end fiber of claim 11, wherein the optical fiber is a large mode area optical fiber.

17. The ablated end fiber of claim 11, wherein the optical fiber has a maximum length of less than 40 millimeters.

18. The ablated end fiber of claim 11, wherein a first subset of the plurality of discrete craters have maximum depths that are greater than maximum depths of a second subset of the plurality of discrete craters.

19. The ablated end fiber of claim 11, wherein the maximum depths of the plurality of discrete craters increase along a direction of light propagation through the optical fiber.
